(19) United States
(12) Patent Application Publication
(10) Pub. No.: US 2013/0058541 A1
(43) Pub. Date: Mar. 7, 2013

(54) IMAGE PROCESSING APPARATUS AND METHOD

(71) Applicant: Akiko Susaki, Tokyo (JP)

(72) Inventor: Akiko Susaki, Tokyo (JP)

(73) Assignee: TOSHIBA TEC KABUSHIKI KAISHA, Tokyo (JP)

(21) Appl. No.: 13/604,789

(22) Filed: Sep. 6, 2012

(30) Foreign Application Priority Data
Sep. 6, 2011 (JP) 2011-193732
Feb. 23, 2012 (JP) 2012-037634

(51) Int. Cl. G06K 9/00

(52) U.S. Cl. 382/110

(57) ABSTRACT

An information processing apparatus comprises a category recognition section, a characteristic recognition section and a specifying section. The category recognition section recognizes the category of a commodity using input imaged images. The characteristic recognition section recognizes the characteristics of a specific attachment attached to the commodity using the input imaged images. The specifying section specifies the specific information of the commodity according to the category of the commodity that is recognized by the category recognition section and the characteristics of the specific attachment recognized by the characteristic recognition section.

### CROSS-REFERENCE TO RELATED APPLICATION

The present application contains subject matter related to that disclosed in Japanese Priority Patent Application JP 2011-193732 filed in the Japan Patent Office on Sep. 6, 2011 and Japanese Priority Patent Application JP 2012-037634 filed in the Japan Patent Office on Feb. 23, 2012 the entire contents of which are hereby incorporated by reference.

### FIELD

Embodiments described herein relate to an information processing apparatus and method.

### BACKGROUND

Conventionally, there is known a technology which compares the commodity image imaged by an imaging device with the images pre-registered in a database to specify the category (e.g. vegetable, fruit, fish, meat) and the name (e.g. mackerel, sardine, radish, cabbage, banana) of a commodity.

### BRIEF DESCRIPTION OF THE DRAWINGS

FIG. 1 is a perspective view showing the external structure of a checkout system using the information processing apparatus and program provided in an embodiment;

FIG. 2 is a block diagram showing the hardware components of a POS terminal and a commodity reading device;

FIG. 3 is a block diagram illustrating the functional components of each CPU;

FIG. 4 is a schematic diagram illustrating an example of the attachment attached to a commodity;

FIG. 5 is a schematic diagram illustrating a structural example of an information specifying table;

FIG. 6 is a schematic diagram illustrating a structural example of a PLU file;

FIG. 7 is a flowchart illustrating the sequence of the processing actions of a commodity reading device;

FIG. 8 is a flowchart illustrating the sequence of the processing actions of a POS terminal;

FIG. 9 is a schematic diagram illustrating a structural example of a display screen displayed on an operator-oriented display.

### DETAILED DESCRIPTION

In accordance with an embodiment, an information processing apparatus comprises a category recognition section, a characteristic recognition section and a specifying section. The category recognition section recognizes the category of a commodity using input imaged images. The characteristic recognition section recognizes the characteristics of a specific attachment attached to the commodity using the input imaged images. The specifying section specifies the specific information of the commodity according to the category of the commodity that is recognized by the category recognition section and the characteristics of the specific attachment recognized by the characteristic recognition section.

The embodiment of the present invention is described below with reference to accompanying drawings.

Generally, the information processing apparatus and method described in the embodiments of the present invention recognize the category of a commodity and the characteristics of a specific attachment attached to the commodity according to the images imaged by an imaging device and then automatically recognize the production place, the size, the quantity, the weight, the grade, the class and other specific information of the commodity, thereby calculating the price of the commodity automatically.

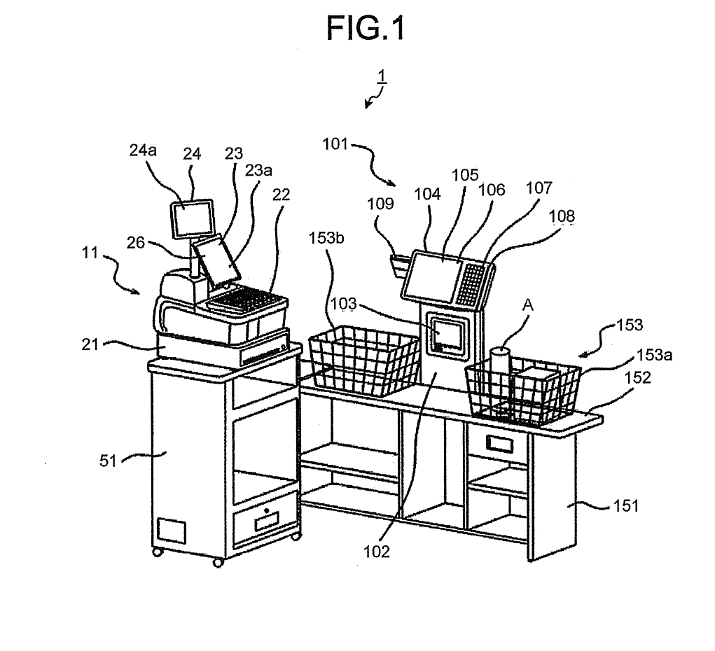

FIG. 1 is a perspective view showing the external structure of a checkout system 1 using the information processing apparatus and method provided in the embodiment.

As shown in FIG. 1, the checkout system 1 is provided with a POS terminal 11 for registering and checking the sales of the commodities settled in one transaction. The POS terminal 11 is held on the upper surface of a cash drawer 21 arranged on a checkout counter 51. The cash drawer 21 is opened under the control of the POS terminal 11.

A keyboard 22 is arranged on the upper surface of the POS terminal 11 for the operator (user) to operate. Seen from the side of the operator of the keyboard 22, a display 23 for displaying information for the operator is arranged more inward that the keyboard 22. The display 23 displays information on the display panel 23a thereof. A touch panel 26 is laminated on the display panel 23a. A vertical customer-oriented display 24 that can be freely rotated is arranged at a position more inward than the display 23. The customer-oriented display 24 displays information on the display panel 24a thereof.

Moreover, the display panel 24a of the customer-oriented display 24 shown in FIG. 1 faces the nearer side shown FIG. 1, however the customer-oriented display 24 can be rotated in such a manner that the display panel 24 faces the far side shown in FIG. 1 so as to display information for the customer. A long desk-shaped counter 151 is arranged which forms an L shape with the checkout counter 51 provided with the POS terminal 11. A commodity receiving surface 152 is formed on the upper surface of the counter 151. A shopping basket 153 for accommodating a commodity A is held on the commodity receiving surface 152. The shopping basket 153 is classified into a first shopping basket 153a that is held by a customer and a second shopping basket 153b that is spaced from the first shopping basket 153a by a commodity imaging device 101.

The commodity imaging device 101, which has a thin rectangular housing 102 and is connected with the POS terminal 11 to transmit data with the POS terminal 11 freely, is arranged on the commodity receiving surface 152 of the counter 151.

A reading window 103 is arranged on the front side of the housing 102. A display operating section 104 is mounted on the upper portion of the housing 102. A display 106 having a touch panel 105 laminated on the surface thereof is arranged on the display operating section 104. A keyboard 107 is arranged on the right of the display 106. The card reading slot 108 of a card reader (not shown) is arranged on the right of the keyboard 107. Seen from the side of the operator, a customer-oriented display 109 for providing information for the customer is arranged behind and on the left of the display operating section 104.

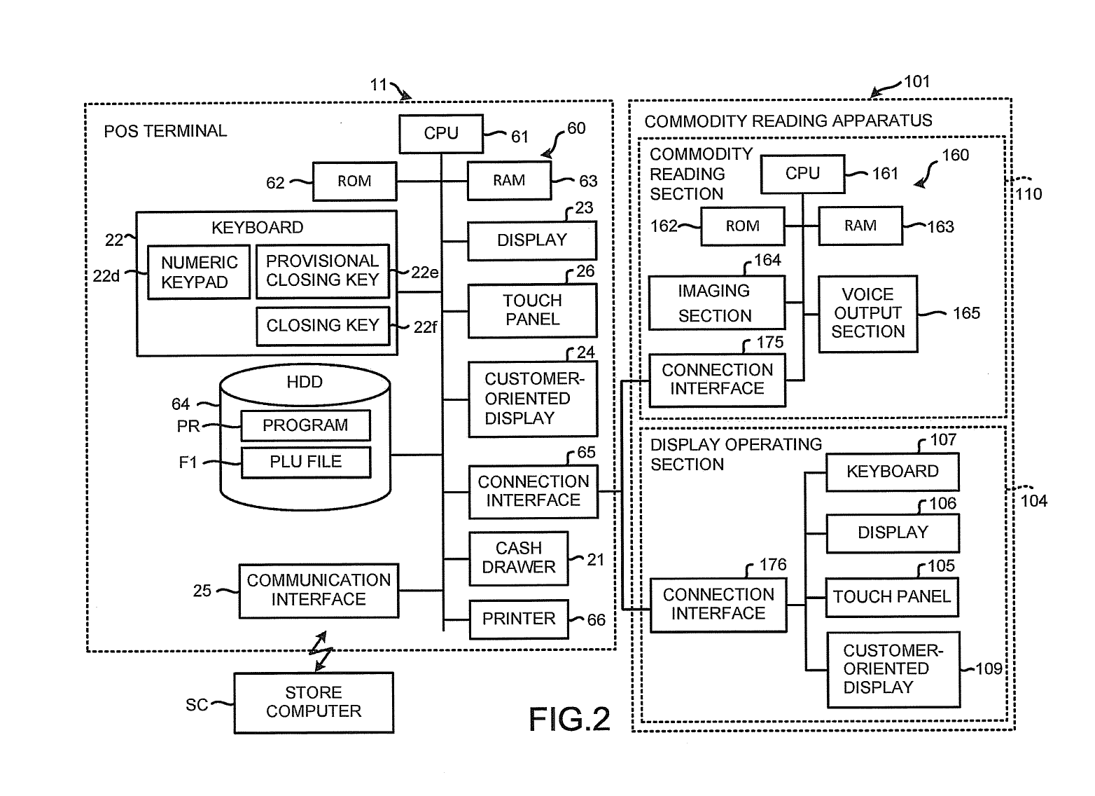

The commodity reading device 101 comprises a commodity reading section 110 (refer to FIG. 2). In the commodity reading section 110, an imaging section (imaging device) 164 (refer to FIG. 2) is arranged behind the reading window 103.

The commodity A to be settled in one transaction is accommodated in the first shopping basket 153a held by the customer. The operator manually moves the commodity A into the second shopping basket 153b. When being moved, the commodity A faces the reading window 103 of the commodity reading device 101. At this time, the imaging section 164 (refer to FIG. 2) behind the reading window 103 images the commodity A.

FIG. 2 is a block diagram showing the hardware components of the POS terminal 11 and the commodity reading device 101. The POS terminal 11 is provided with a micro computer 60 functioning as an information processing unit for carrying out an information processing. The micro computer 60 is formed by connecting a CPU (Central Processing Unit) 61 which carries out various operations to control each other unit with an ROM (Read Only Memory) 62 and an RAM (Random Access Memory) 63 via a bus line.

The keyboard 22 includes a numeric keypad 22d having numeric characteristics such as ‘1’, ‘2’, ‘3’ and a multiply operation such as ‘*’ indicated on the upper surface thereof, a subtotal key 22e and a total key 22f.

The CPU 61 of the POS terminal 1 is connected with an HDD (Hard Disk Drive) 64, in which various programs and files are stored. When run in the POS terminal 11, the programs and files stored in the HDD 64 are all or partially copied into the RAM 63 to be sequentially executed by the CPU 61.

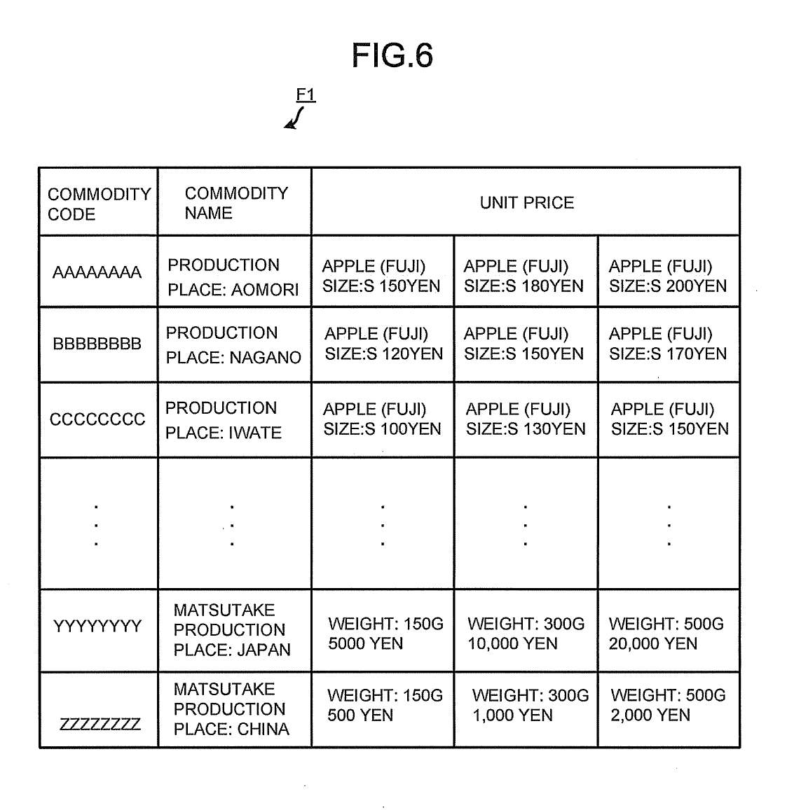

An example of the program stored in the HDD 64 is a commodity sales data processing program PR, and an example of the file stored in the HDD 64 is a pre-stored PLU file F1 (refer to FIG. 6) that is sent from a store computer SC. The PLU file F1 is a file setting the sales registration information of a commodity sold in a shop.

Return to FIG. 2, the CPU 61 of the POS terminal 11 is connected with a communication interface 25 that communicates in data with the store computer SC via an input-output circuit (not shown). The store computer SC is arranged in the backyard of a shop. The PLU file F1 to be sent to the POS terminal 11 is stored in the HDD (not shown) of the store computer SC.

The CPU 61 of the POS terminal 11 is further connected with a connection interface 65 that can transmit data with the commodity reading device 101. The connection interface 65 is connected with the commodity reading device 101. Moreover, the CPU 61 of the POS terminal 11 is connected with a printer 66 for printing invoices. The POS terminal 11 prints the content of a transaction on a receipt under the control of the CPU 61.

The commodity reading device 101 also has a micro computer 160, which is formed by connecting a CPU 161 with an ROM 162 and an RAM 163 via a bus line. The programs executed by the CPU 161 are stored in the ROM 162. The CPU 161 is connected with the imaging section 164 and a voice output section 165 via various input/output circuits (not shown). The imaging section 164 and the voice output section 165 act under the control of the CPU 161. The display operating section 104 is connected with the POS terminal 11 via a connection interface 176 and acts under the control of the CPU 161 of the POS terminal 11.

The imaging section 164 is a color CCD image sensor or a color CMOS image sensor which images an image from the reading window 103 under the control of the CPU 161. For instance, the imaging section 164 images dynamic images at 30 fps. The frame images (images) sequentially imaged by the imaging section 164 at a given frame rate are stored in the RAM 163.

The voice output section 165 is a voice circuit or loudspeaker that is configured to sound a preset warning tone. Under the control of the CPU 161, the voice output section 165 makes a report by sounding a warning tone.

Further, the CPU 161 is connected with a connection interface 175 which is connected with the connection interface 65 of the POS terminal 11 to transmit data with the POS terminal 11. The specific information (production place, size and quantity) of the commodity that is specified based on the category of the commodity A recognized from the images imaged by the imaging section 164 of the commodity reading device 101 and the characteristics of the attachment AT attached to the commodity A and the category information of the commodity are output through the connection interface 175 under the control of the CPU 161 and then output to the POS terminal 11 through the connection interface 65.

The functions of the POS terminal 11 and the commodity reading device 101 of the checkout system 1 provided in this embodiment are roughly described here.

The commodity reading device 101 provided in this embodiment recognizes the category of the commodity A and the characteristics of the attachment AT attached to the commodity A using the images imaged by the imaging section 164, specifies the specific information (production place, size or quantity) of the commodity A, and sends the category information of the commodity A and the specified specific information to the POS terminal 11. On the other hand, the POS terminal 11 provided in this embodiment acquires the unit price information of the commodity A based on the information (the category information and the specific information) received from the commodity reading device 101 to carry out the checkout processing for the commodities settled in one transaction.

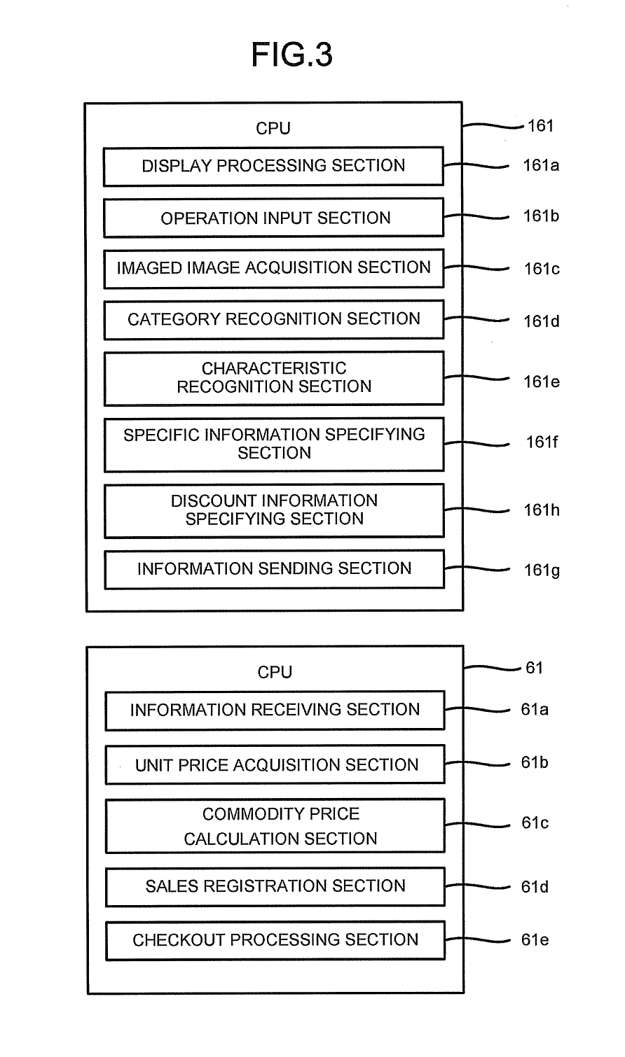

Next, the functional components of the CPU 161 and the CPU 61 achieved by the sequential program running of the CPU 161 and the CPU 61 are described below with reference to FIG. 3. FIG. 3 is a block diagram illustrating the functional components of the CPU 161 and the CPU 61.

As shown in FIG. 3, by executing programs sequentially, the CPU 161 gains the functions of a display processing section 161a, an operation input section 161b, an imaged image acquisition section 161c, a category recognition section 161d, a characteristic recognition section 161e, a specific information specifying information 161f, a discount information specifying section 161h and an information sending section 161g.

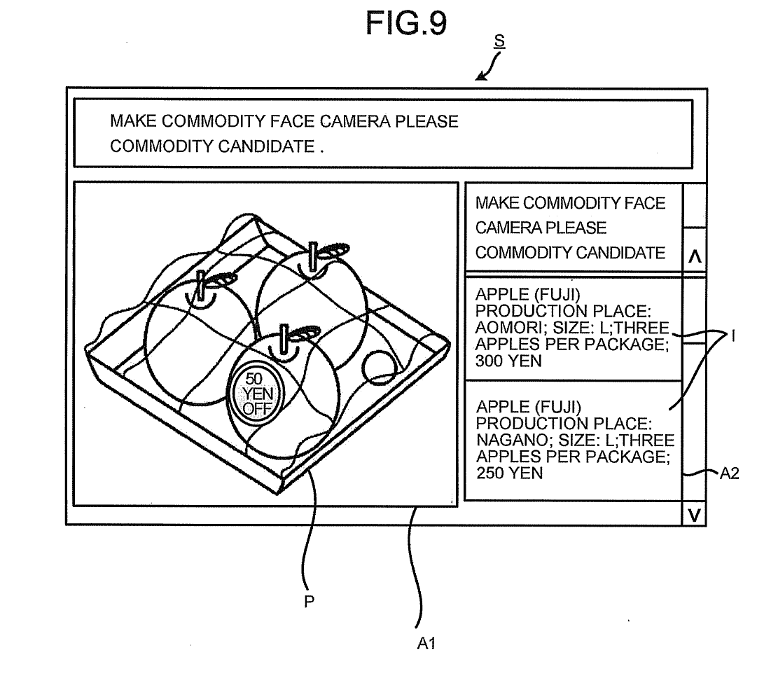

Here, the display processing section 161a displays information on the operator-oriented display 106, and in this embodiment, the display processing section 161a displays the commodity specifying screen S shown in FIG. 9. FIG. 9 is a schematic diagram illustrating a structural example of the commodity specifying screen S displayed on the display 106. As shown in FIG. 9, the commodity specifying screen S contains an imaging area A1 for displaying the image P of the commodity A imaged by the imaging section (imaging device) 164 and a candidate display area A2 for displaying a candidate I (commodity candidate) for the recognized category of the commodity A displayed on the imaging area A1.

The operation input section 161b inputs the operation of the operator on the keyboard 107 or the touch panel 105, and in this embodiment, the selection of the operator on a commodity candidate is accepted from the commodity specifying screen S shown in FIG. 9.

The imaged image acquisition section 161c outputs an imaging-on signal to the imaging section 164 to activate the imaging section 164 to carry out an imaging and sequentially acquires the frame images (imaged images) that are imaged by the imaging section 164 and stored in the RAM 163. The imaged image acquisition section 161c acquires the frame images in accordance with the storage order of the images in the RAM 163.

The category recognition section 161d recognizes the category of the commodity A using the images that are imaged by the imaging section 164. More specifically, the category recognition section 161d reads, using the imaged images, the surface states (surface color, appearance (pattern), flatness level) of the commodity A as characteristics and compares the read characteristics with the pre-registered characteristics of the commodity A of each category, thereby recognizing the category of the commodity A serving as a specific object.

The recognition of an object contained in an image is referred to as generic object recognition, which is carried out by various recognition methods that are respectively illustrated in the following documents:

ANAI Keiji, ‘The current state and further directions on Generic Object Recognition’, in Proceedings of Information Processing Society of Japan, Vol. 48, No SIG 16, In URL:http://mm.cs.uec.ac.jp/IPSJ-TCVIM-Yanai.pdf [retrieved on Aug. 10, 2010].

In addition, the technology for recognizing a generic object through a target-aimed regional image segmentation is described in the following document:

Jamie Shotton: “Semantic Texton Forests for Image Categorization and Segmentation, In URL:http://citeseerx.ist.psu.edu/viewdoc/download?doi=10.1.1.145.3036&rep=repl&type=pdf (retrieved on Aug. 10, 2010).

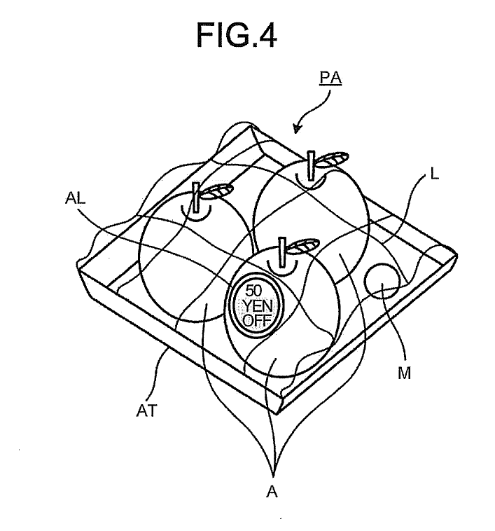

The characteristic recognition section 161e recognizes the characteristics of the specific attachment AT (refer to FIG. 4) attached to the commodity A and the characteristics of the specific attachment mark M (refer to FIG. 4) attached to the attachment AT using the images imaged by the imaging section 164. Here, the specific attachment AT refers to, for example, an element (tray) for holding the commodity A, an element (seal) attached to the commodity A or an element (mesh bag) for accommodating the commodity A, and the specific attachment mark M refers to, for example, an element (seal) attached to the attachment AT or an element (rope) buckled on the attachment AT, and the characteristic recognition section 161e recognizes the colors and shapes or the elements. FIG. 4 is a schematic diagram illustrating an example of the attachment AT attached to the commodity A. In the example shown in FIG. 4, the attachment AT is a tray for holding a packaged commodity PA made up of a plurality of commodities A that are wound together. In this example, the color of the tray serving as an attachment AT is ‘orange’.

The specific information specifying section 161f specifies the specific information of the commodity A representing at least one of production place, size, quantity, weight, grade and class according to the category of the commodity A recognized by the category recognition section 161d and the characteristics (color, shape) of the attachment AT and the attachment mark M recognized by the characteristic recognition section 161e.

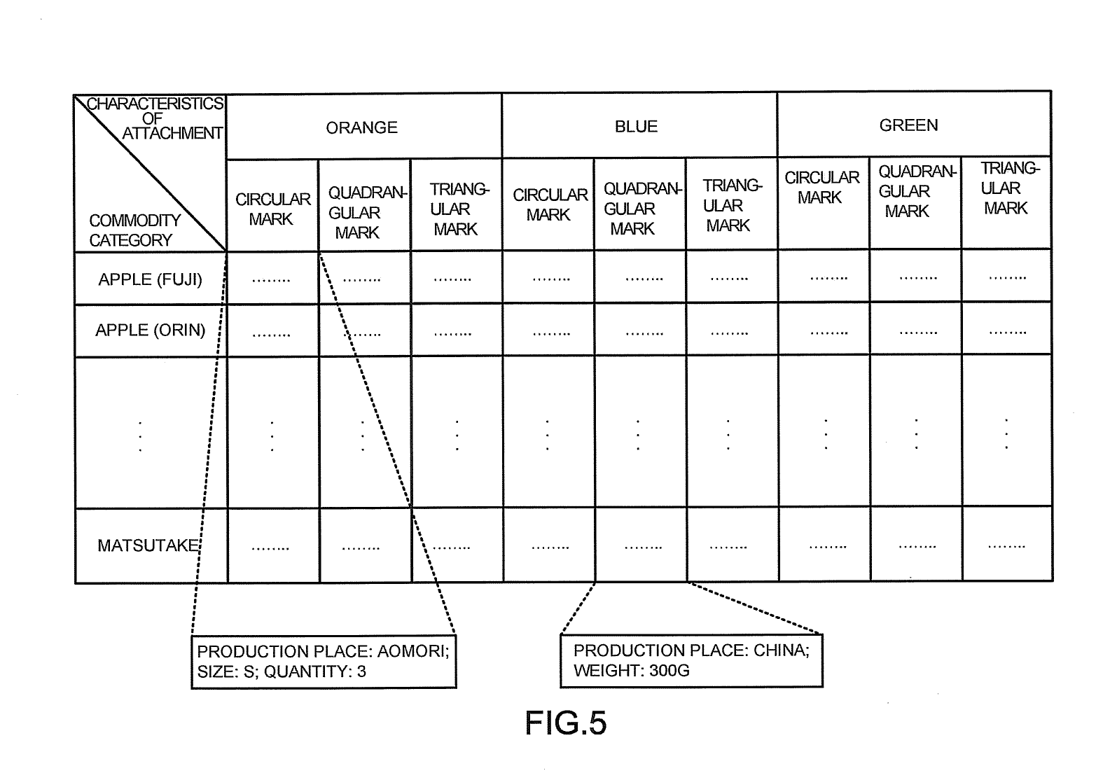

More specifically, by reference to a pre-stored information specifying table T1 (refer to FIG. 5), the specific information specifying section 161f specifies the specific information of the commodity A representing at least one of production place, size, quantity, weight, grade and class based on the recognized category of the commodity A and the characteristics of the attachment AT. FIG. 5 is a schematic diagram illustrating a structural example of the information specifying table T1. As shown in FIG. 5, the information specifying table T1 is a table in which the category of the commodity A is associated with the characteristics of the attachment AT to represent at least one of the production place, the size, the quantity, the weight, the grade and the class of the commodity A by grade. Moreover, in the example shown in FIG. 5, in the case where the category of the commodity A is Apple (Fuji)) and the attachment AT is a tray for holding the packaged commodity PA, specific information ‘Production Place: Aomori; Size: S; Quantity: 3’ is registered as specific information by associating the color (Orange) of the attachment AT with the attachment mark M (circular mark) attached to the attachment AT, and in the case where the category of the commodity A is MATSUTAKE and the attachment AT is a tray for holding the packaged commodity PA, specific information ‘Production Place: China; Weight: 300 g’ is registered as specific information by associating the color (Blue) of the attachment AT with the attachment mark M (quadrangular mark) attached to the attachment AT.

The discount information specifying section 161h specifies, using the generic object recognition technology, the discount information (e.g. 50 Yen off) shown by the discount label AL attached to the packaged commodity PA according to the images imaged by the imaging section 164. Specifically, the discount information specifying section 161h reads, using the imaged images, the surface states (surface color, appearance (pattern) containing the discount information (50 Yen off) of the packaged commodity PA) of the discount label AL as characteristics, and compares the read characteristics with the characteristics of a pre-registered discount label AL to specific the discount information shown by the discount label AL.

The information sending section 161g sends the category information representing the category of the commodity A recognized by the category recognition section 161d, the specific information of the commodity A representing at least one of production place, size, quantity, weight, grade and class specified by the specific information specifying information 161f and the discount information specified by the discount information specifying section 161h to the POS terminal 11.

Moreover, as shown in FIG. 3, by executing programs sequentially, the CPU 61 gains the functions of an information receiving section 61a, a unit price acquisition section 61b, a commodity price calculation section 61c, a sales registration section 61d and a checkout processing section 61e.

The information receiving section 61a receives the information sent from the information sending section 161g of the commodity reading device 101, that is, the information containing the category information, the specific information and the discount information.

The unit price acquisition section 61b retrieves the PLU file F1 shown in FIG. 6 based on the information (the category information representing the category of the commodity A, the information representing the production place and the size of the commodity A and the information representing the weight of the packaged commodity PA) received by the information receiving section 61a to acquire the price information representing the unit price of the commodity A specified by the specific category information. FIG. 6 is a schematic diagram illustrating a structural example of the PLU file F1. As shown in FIG. 6, the PLU file F1 is a file which stores, aiming at the commodity ID (commodity code) uniquely distributed to the commodity A, the information related to the commodity A such as commodity name and unit price.

The commodity price calculation section 61c calculates, according to the unit price information acquired by the unit price acquisition section 61b and the quantity information and the discount information contained in the information received by the information receiving section 61b, the sale price of the packaged commodity PA, that is, the commodity made up of a plurality of the commodities A that are wound together.

The sales registration section 61d records the commodity ID (commodity code), the commodity name and the unit price of the commodity A that is read by the commodity reading device 101 and specified as a commodity in a sales primary file to register the sales of the commodity A.

The checkout processing section 61e carries out the checkout processing for the commodities settled in one transaction registered by the sales registration section 61d.

The detailed processing actions of the checkout system 1 with the structure above are described below.

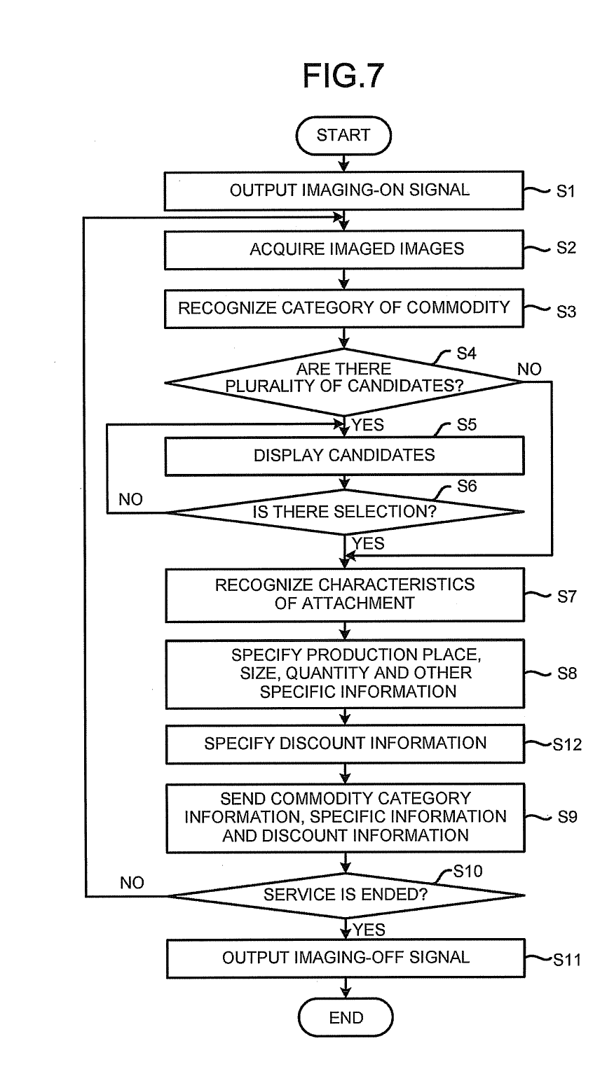

The processing actions of the commodity reading device 101 are described first. FIG. 7 is a flowchart illustrating the sequence of the processing actions of the commodity reading device 101.

As shown in FIG. 7, when the POS terminal 11 starts to carry out a processing by registering commodities, the imaged image acquisition section 161c outputs an imaging-on signal to the imaging section 164 to activate the imaging section 164 to carry out an imaging (Act S1). Next, the imaged image acquisition unit 161 acquires the frame images (imaged images) that are imaged by the imaging section 164 and then stored in the RAM 163 (Act S2).

Then, the category recognition section 161d recognizes the category (e.g. Apple (Fuji)) of the commodity A using the acquired images (Act S3).

Here, for the recognition result of Act S3, there may be a plurality of candidates for the recognized category of the commodity A. Thus, if there are a plurality of candidates for the recognized category of the commodity A (Act S4: Yes), the CPU 161 displays the commodity specifying screen S shown in FIG. 9 on the display 106, the candidates (commodity candidates) for the recognized category of the commodity A are displayed in the candidate display area A2 of the commodity specifying screen S (Act S5), and the plurality of commodity candidates are reported to the operator (cashier).

Then, the CPU 161 determines that a correct commodity candidate is selected by the operator through the touch panel 105 (Act S6: Yes), and the flow proceeds to Act S7.

On the other hand, if there are not a plurality of candidates for the recognized category of the commodity A, that is, there is only one category (Act S4: No), the CPU 61 directly executes Act S7, ignoring Acts S5 and S6.

Next, in Act S7, the characteristic recognition section 161e recognizes, using the acquired images, the characteristics (color, shape) of the specific attachment AT attached to the commodity A. Moreover, if the characteristics of the attachment AT cannot be recognized in Act S7, that is, the attachment AT is not imaged by the imaging section 164, the operator displays, on the commodity specifying screen S (refer to FIG. 9) displayed on the display 106, indication information such as ‘make the tray face the reading window 103 please’ or ‘rotate the commodity A to be in front of the reading window 103 please’ so that the operator (cashier) can image the attachment AT using the imaging section 164.

Then, by reference to the information specifying table T1, the specific information specifying section 161f specifies corresponding specific information (production place, size, quantity, weight, grade, class) based on the category of the commodity A recognized in Act S3 and the characteristics of the attachment AT recognized in Act S7 (Act S8).

Sequentially, the discount information specifying section 161h specifies the discount information (e.g. 50 Yen off) shown by the discount label AL using the imaged images on condition that the image of the discount label AL attached to the packaged commodity PA is contained in the imaged images acquired in Act S2 (Act S12).

Next, the information sending section 161g sends the category information representing the category of the commodity A recognized in Act S3, the specific information specified in Act S8 and the discount information representing the discount amount specified in Act S12 to the POS terminal 11 (Act S9).

Then, the CPU 161 determines whether or not a commodity registration ending indication is sent from the POS terminal 11 to end the service (Act S10). Here, if the service is continued (Act S10: No), the CPU 161 returns to Act S2 to continue the processing. On the other hand, if the service is ended (Act S10: Yes), the imaged image acquisition section 161c outputs an imaging-off signal to the imaging section 164 to end the imaging of the imaging section 164 (Act S11), then the processing is ended.

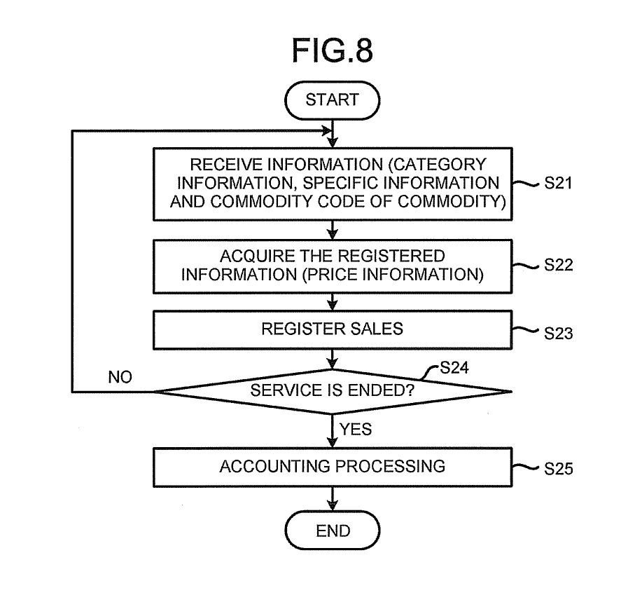

Next, the processing actions carried out by the POS terminal 11 are described. FIG. 8 is a flowchart illustrating the sequence of the processing actions of the POS terminal 11.

As shown in FIG. 8, in the POS terminal 11, the information receiving section 61a receives commodity code information and the information containing the category information, the specific information and the discount information from the commodity reading device 101, then, by reference to the PLU file F1, the unit price acquisition section 61b acquires, based on the information received, registration information containing the price information representing the unit price of the commodity A specified by the category information.

Then, in the POS terminal 11, the sales registration section 61d registers the sales information of the commodity in a sales primary file based on the registration information acquired in Act S22 (Act S23).

Moreover, if discount information is received in Act S21, then in Act S23, the sales price of the packaged commodity PA is calculated according to the price information acquired by the unit price acquisition section 61b and the discount information received in Act S21 and then registered in the sales primary file as sales information. For instance, if the price information acquired by the unit price acquisition section 61b is ‘150 Yen’, the quantity information contained in the specific information received in Act S21 is ‘3’, and the discount information received in Act S21 is ‘50 Yen off’, the sales registration section 61d calculates the sales price of the packaged commodity PA according to the following formula: (3*150(Yen)−50(Yen)=400 (Yen).

Then, in the POS terminal 11, the CPU 61 determines whether or not the service is ended as the sales registration is ended by an operation indicator (a press on the total key 22f) given from the keyboard 22 (Act S24). Here, if the service is ended (Act S24: Yes), the checkout processing section 61e carries out the checkout processing for the commodity A sold in one transaction (Act S25), and the CPU 61 ends the processing after the checkout processing is completed. On the other hand, if the service is continued (Act S24: No), the CPU 161 returns to Act S21 to continue the processing.

Next, an example of the specific processing shown in FIG. 7 and FIG. 8 is described below.

For instance, the following processing is described: in the case where the customer carries the shopping basket 153 containing the packaged commodity PA (that is, the commodity wrapped by a piece of preservative film L and containing three apples (Fuji) serving as the commodity A and an orange tray AT on which the apples are placed and to which a circular mark is attached) shown in FIG. 4 to the counter 151 for checkout, the category of the commodity A contained in the packaged commodity PA is specified (that is, only one category).

In this case, the operator (cashier) uses the keyboard 22 to instruct the POS terminal 11 to start to register the commodity, takes the packaged commodity PA out from the shopping basket 153 and makes the packaged commodity PA face the reading window 103 to image the packaged commodity PA using the imaging section 164. That is, at this time, in the commodity reading device 101, in Act S1, the imaged image acquisition section 161c outputs an imaging-on signal to the imaging section 164 to activate the imaging section 164 to carry out an imaging, then in Act S2, the imaged image acquisition section 161c acquires the frame image (imaged image) that is imaged by the imaging section 164 and then stored in the RAM 163, that is, acquires the image of the packaged commodity PA.

Then, in Act S3, the category recognition section 161d recognizes, using the acquired image, ‘Apple (Fuji)’ as the category of the commodity A contained in the packaged commodity PA. Next, in Act S7, the characteristic recognition section 161e recognizes, using the acquired image, ‘orange’ as the color of the specific attachment AT attached to the commodity A and ‘circular’ as the shape of the attachment mark M.

Then, in Act S8, by reference to the information specifying table T1, the specific information specifying section 161f specifies corresponding specific information ‘Production Place: Aomori; size: S; quantity: 3’ based on the category ‘apple (Fuji)’ of the commodity A recognized in Act S3 as well as the characteristic ‘orange’ of the attachment AT and the characteristic ‘circular’ of the attachment mark M recognized in Act S7.

Next, in Act S9, the information sending section 161g sends the category information ‘apple (Fuji)’ of the commodity A recognized in Act S3 and the specific information specified in Act S8, that is, the information ‘Production Place: Aomori; size: S; quantity: 3’, to the POS terminal 11.

On the other hand, in the POS terminal 11, in Act S21, the information receiving section 61a receives, from the commodity reading device 101, the information containing the category information (the information representing the category ‘apple (Fuji)’ of the commodity A) and the specific information (the information representing ‘Production Place: Aomori; size: S; quantity: 3’)), and then in Act S22, by reference to the PLU file F1, the unit price acquisition section 61b acquires registration information containing the unit price information ‘150 Yen’ of the commodity A specified by the category information based on the received information, that is, the information representing category information ‘apple (Fuji)’ of the commodity A and the specific information ‘Production Place: Aomori; size: S; quantity: 3’.

Then, in Act S23, the sales registration section 61d registers commodity the sales information of the commodity based on the registration information acquired in Act S22, if it is determined in the following Act S24 that the service is ended (Act S24: Yes), then in Act S25, the checkout processing section 61e carries out the checkout processing for the commodity settled in one transaction. That is, in this case, the checkout processing section 61e calculates the price of the packaged commodity PA according to the unit price information ‘150 Yen’ acquired in Act S22 and the quantity information ‘quantity: 3’ contained in the information received in Act S21 and then carries out a checkout processing (charge calculation processing or invoice issuing processing).

Next, another example of the specific processing is described below.

For instance, the following processing is described: when the customer carries the shopping basket 153 containing a packaged commodity PA wrapped by a piece of preservative film L and containing a MATSUTAKE (Production Place: China) and a blue tray AT on which the MATSUTAKE is placed and to which a quadrangular mark is attached to the counter 151 for checkout, the category of the commodity A contained in the packaged commodity PA is specified (that is, only one category).

In this case, in Act S3, the category recognition section 161d recognizes, using the acquired images, ‘MATSUTAKE’ as the category of the commodity A contained in the packaged commodity PA. Next, in Act S7, the characteristic recognition section 161e recognizes, using the acquired images, ‘blue’ as the color of the specific attachment AT attached to the commodity A and ‘quadrangular’ as the shape of the attachment mark M.

Then, in Act S8, by reference to the information specifying table T1, the specific information specifying section 161f specifies ‘Production Place: China; Weight: 300 g’ as corresponding specific information based on the category ‘MATSUTAKE’ of the commodity A recognized in Act S3 as well as the characteristic ‘blue’ of the attachment AT and the characteristic ‘quadrangular’ of the attachment mark M recognized in Act S7.

Next, in Act S9, the information sending section 161g sends the category information ‘MATSUTAKE’ of the commodity A recognized in Act S3 and the specific information specified in Act S8, that is, the information ‘Production Place: China; Weight: 300 g’, to the POS terminal 11.

On the other hand, in the POS terminal 11, in Act S21, the information receiving section 61a receives, from the commodity reading device 101, information containing the category information (the information representing the category ‘MATSUTAKE’ of the commodity A) and the specific information (Production Place: China; Weight: 300 g), and then in Act S22, by reference to the PLU file F1, the unit price acquisition section 61b acquires registration information containing the unit price information ‘1000 Yen’ of the commodity A specified by the category information based on the received information, that is, the information representing category information ‘MATSUTAKE’ of the commodity A and the specific information ‘Production Place: China; Weight: 300 g’.

Then, in Step S23, the sales registration section 61d registers the sales information of the commodity based on the registration information acquired in Step S22, if it is determined in the following Step S24 that the service is ended (Step S24: Yes), then in Step S25 the checkout processing section 61e carries out the checkout processing for the commodities settled in one transaction. That is, in this case, the checkout processing section 61e carries out a checkout processing (charge calculation processing or invoice issuing processing) by taking the unit price information ‘1000 Yen’ acquired in Step S22 as the price ‘1000 Yen’ of the packaged commodity PA.

In accordance with the embodiment described above, the specific information (production place, size, quantity) of a commodity can be specified according to the image of the commodity imaged by the imaging section (imaging device) 164. Moreover, in this embodiment, the price of the commodity can be calculated based on the specific information (production place, size, quantity) of the specified commodity.

That is, in accordance with this embodiment, the POS terminal 11 specifies the specific information (Production Place; Size; Quantity) of a commodity and calculates the price of the commodity automatically, thus, the operator is free from tedious operations, that is, what the operator (cashier) needs to do is only to visually recognize the production place, the size and the quantity of the commodity and to manually input the commodity price to the POS terminal 11 based on the recognition result and a given price list.

Moreover, in accordance with this embodiment, the POS terminal 11 recognizes the production place and the size of a commodity automatically, thus, the operator is relieved when carrying out a checkout processing.

The present invention is described based on the exemplary embodiment above but should not be construed to be limited to the exemplary embodiment above.

For instance, in the embodiment above, the specific attachment AT attached to the commodity A for holding the commodity A is a tray on which the packaged commodity A is placed, however, the present invention is not limited to this, the attachment AT may also be a seal attached to the commodity A, a mesh bag for accommodating the commodity A and the like.

Further, in the embodiment above, the specific attachment AT is attached with an attachment mark M, and the characteristics (color, shape) of the attachment AT and the attachment mark M are recognized, however, the attachment AT may be attached with no attachment mark M, and only the characteristics (color, shape) of the attachment AT are recognized.

Further, in the embodiment above, the attachment attached to the attachment AT is an attachment mark M, however, the present invention is not limited to this, the attachment attached to the attachment AT may also be a label, rope and the like.

Further, in the embodiments above, the color of the attachment AT and the shape of the attachment mark M are respectively recognized as characteristics of the attachment AT and the attachment mark, however, the present invention is not limited to this, the shape (circular, triangular or quadrangular if the attachment AT is seal) of the attachment AT and the color of the attachment mark may be recognized.

Further, in the embodiment above, the discount information specifying section 161h specifies discount information according to the discount label AL attached to the commodity PA, however, the present invention is not limited to this, if the specific information stored in the information specifying table (refer to FIG. 5) in which the characteristic (color) of the attachment AT is associated with the characteristic (shape) of the attachment mark M contains discount information (e.g. 50 Yen off), the specific information specifying section 161f may also specify the specific information containing the discount information according to the characteristics of the attachment AT and the attachment mark M recognized by the characteristic recognition section 161e.

Further, in the embodiments above, the commodity reading device 101 carries out a processing (processing A) to specify at least one of the production place, the size and the quantity of the commodity A, and the POS terminal 11 carries out a processing (processing B) to calculate the price of the commodity A or a commodity (packaged commodity PA) consisting of a plurality of bound commodities Abased on the information received from the commodity reading device 101, however, the present invention is not limited to this, the processing A and the processing B may be both carried out by either of the commodity reading device 101 or the POS terminal 11.

Further, in the embodiment above, the specific information (production place, size, quantity, weight, grade, class) of the commodity A is specified using the information specifying table T1 shown in FIG. 5 and the PLU file F1 shown in FIG. 6, and the price of the commodity A or a commodity (packaged commodity PA) consisting of a plurality of bound commodities A is calculated, however, the present invention is not limited to this, different tables and files may be formed using the table shown in FIG. 5 and the file shown in FIG. 6.

For instance, the information specifying table T1 may be a table in which a commodity code is registered by associating the category of the commodity A with the characteristics of the attachment AT, on the other hand, the PLU file F1 may be a file in which the commodity name (e.g. Apple (Fuji); Production Place: Aomori; Size: S; Three Apples per Package; Apple (Fuji); Production Place Nagano; Size: S; Three Apples per Package;) of a packaged commodity or a commodity accommodated in a mesh bag is registered in association with a commodity code, the commodity reading device 101 specifies the commodity code and sends the specified commodity code to the POS terminal 11, and the POS terminal 11 calculates the price of THE commodity A related to the received commodity code.

Further, in the embodiment above, the specific information specified by the specific information specifying section 161f refers to the production place, the size, the quantity, the weight, the grade and the class of the commodity A, however, the present invention is not limited to this, the specific information may be other information.

Further, in the embodiment above, the checkout system consists of the POS terminal 11 operated by a shop assistant (cashier) and the commodity reading device 101, however, the present invention is not limited to this, the checkout system may also be a well-known automatic checkout system.

Further, in the embodiment above, the information processing apparatus and program provided in this embodiment are applied to the POS terminal 11 and the commodity reading device 101, however, the present invention is not limited to this, the same information processing apparatus and program may also be applied to other informant processing apparatus.

Further, the programs executed by the POS terminal 11 and the commodity reading apparatus 101 in this embodiment are compiled in the ROM or another memory in advance, or stored in a computer-readable memory medium as an installable or executable file, or provided or released by a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a category recognition section configured to recognize the category of a commodity using input imaged images;
a characteristic recognition section configured to recognize the characteristics of a specific attachment attached to the commodity using the input imaged images; and
a specifying section configured to specify the specific information of the commodity according to the category of the commodity that is recognized by the category recognition section and the characteristics of the specific attachment recognized by the characteristic recognition section.

2. The information processing apparatus according to claim 1, wherein
the specifying section specifies the specific information representing at least one of the production place, the size, the quantity, the weight, the grade and the class of the commodity.

3. The information processing apparatus according to claim 1, further comprising:
an acquisition section configured to acquire the price of the commodity from the specific information specified by the specifying section.

4. The information processing apparatus according to claim 3, further comprising:
a discount information specifying section configured to specify discount information using the specific attachment attached to the commodity; and
a commodity price calculation section configured to calculate the sales price of the commodity according to the price acquired by the acquisition section and the discount information specified by the discount information specifying section.

5. The information processing apparatus according to claim 3, wherein
the specifying section specifies the specific information representing the weight of the commodity; and
the acquisition section acquires the price of the commodity from the specific information representing the weight of the commodity specified by the specifying section.

6. The information processing apparatus according to claim 1, wherein
the specific attachment is an element for holding the commodity, an element attached to the commodity or an element for accommodating the commodity; and
the characteristic recognition section recognizes the color or the shape of the element.

7. The information processing apparatus according to claim 1, further comprising:
a storage section configured to store a table in which the specific information representing at least one of the production place, the size, the quantity, the weight, the grade and the class of the commodity is registered by associating with the category of the commodity and the characteristics of the attachment; wherein
the specifying section specifies the specific information by reference to the table according to the category of the commodity that is recognized by the category recognition section and the characteristics of the specific attachment recognized by the characteristic recognition section.

8. A method, comprising:
recognizing the category of a commodity using input imaged images;
recognizing the characteristics of a specific attachment attached to the commodity using the input imaged images; and
specifying the specific information of the commodity according to the category of the commodity that is recognized and the characteristics of the specific attachment recognized.
